(19) United States
(12) Patent Application Publication
(10) Pub. No.: US 2024/0167920 A1
(43) Pub. Date: May 23, 2024

(54) COMPOSITION AND METHOD FOR THREE-DIMENSIONAL HISTOLOGICAL STAINING

(71) Applicant: JelloX Biotech Inc., Hsinchu county (TW)

(72) Inventors: Yu-Han Hsieh, Hsinchu county (TW); Yi-Wen Lin, Hsinchu county (TW); YU-CHIEH LIN, Hsinchu county (TW); YEN-YIN LIN, Hsinchu county (TW)

(73) Assignee: JelloX Biotech Inc., Hsinchu county (TW)

(21) Appl. No.: 18/510,652

(22) Filed: Nov. 16, 2023

Related U.S. Application Data
(60) Provisional application No. 63/384,097, filed on Nov. 17, 2022.

(51) Int. Cl. G01N 1/30; G01N 1/34; G01N 1/36; G01N 1/28

(52) U.S. Cl. CPC G01N 1/30; G01N 1/34; G01N 1/36; G01N 2001/2873; G01N 2001/302

(57) ABSTRACT

This disclosure presents a composition for tissue staining and 3D specimen optical clearing, along with a method of making biological material transparent and labeling it simultaneously. The composition includes an amide dye adjuvant, a RI-matching material, a permeating agent, a labeling material, a mixture homogeneity excipient, and a solvent with DMSO. The RI-matching material includes a contrast agent and sugar. The composition has a neutral or acidic pH. The method involves fixing a specimen with a fixative solution and immersing and incubating the specimen in the composition for permeation. This disclosure also presents a kit for rendering biological material transparent. The kit is helpful for experimental animal/human histological studies and cancer staging/tumor differentiation determination.

### CROSS-REFERENCES

The present application claims priority to U.S. Provisional Application Ser. No. 63/384,097, filed on Nov. 17, 2022, which are hereby incorporated by reference in their entirety.

### TECHNICAL FIELD OF THE INVENTION

This disclosure relates to a composition and a method used in the field of biological tissue analysis, and more particularly, to a composition of an aqueous clearing solution for rendering a biological tissue and making it transparent, and the method of using the composition.

### BACKGROUND OF THE INVENTION

Traditionally, the methods for studying the structure of biological tissues in biology research involve the use of hematoxylin and eosin (H&E) staining. This method primarily stains the cellular morphology of the biological tissue, specifically using hematoxylin to stain the cell nuclei and eosin to stain the cytoplasm. The stained tissue can be observed under a microscope in a two-dimensional (2D) plane with visible light. H&E staining has become the standard method for staining pathology sections in hospitals. Moreover, H&E staining can also be used to observe the actual three-dimensional (3D) morphology of biological tissues. In this case, the tissue must be serially sectioned, and each section must be stained with H&E. Afterward, all the stained sections are reassembled to create the actual 3D tissue morphology. The significant drawbacks of this method include its time-consuming nature, the need for more materials, and higher costs, which make it less applicable to smaller or less accessible tissues. Additionally, it does not allow for the direct observation of 3D tissue changes.

On the other hand, fluorescence confocal microscopy and optical clearing were first developed in neural topology to study the distribution and changes of neurons in 3D tissues. Specifically, it involves rendering the tissue transparent and visible to the naked eye. It combines the multi-layer imaging characteristic of confocal microscopy to stack each layer of fluorescence image into a 3D image. As technology has evolved, more advanced techniques have gradually found applications in academic or clinical fields beyond neurology. However, there is a low similarity between the imaging results obtained from various fluorescent dyes/staining methods and traditional H&E staining images since. This discrepancy leads to a contrast gap between traditional histology and 3D fluorescence histology, making it more challenging to integrate 3D fluorescence histology into current medical systems. Therefore, there is an urgent need for a composition and method that combines H&E staining with various fluorescent dyes/staining methods to integrate 3D fluorescence histology into current medical systems through microscopy imaging.

Furthermore, recent studies have combined the self-fluorescence property of eosin dye with tissue-clearing methods, applying this approach to investigate the 3D morphology of biological tissues. However, most tissue-clearing methods combined with eosin staining require tissue dehydration, which is cumbersome and time-consuming. Moreover, not all the tissue-clearing methods are compatible with eosin staining which causes fluorescence quenching or insoluble with eosin. Therefore, there is a need for a simpler and more efficient staining method.

### SUMMARY OF THE INVENTION

The present disclosure reveals a composition for tissue staining and optical clearing of three-dimensional (3D) specimen. The composition includes an amide dye adjuvant, a Refractive Index (RI) matching material, a permeating agent containing a surfactant, a first labeling material having a bromine derivative of fluorescein, a mixture homogeneity excipient having a hydrophilic-lipophilic balance (HLB) value from about 14 to 18, and a solvent containing Dimethyl sulfoxide (DMSO). Further, the RI matching material includes a contrast agent and a sugar, and a concentration of the amide dye adjuvant is from about 10 to 30% (w/v). The pH of the composition is neutral or acidic.

In some embodiments, the amide dye adjuvant includes acetamide, urea, or a derivative thereof.

In some embodiments, a concentration of the sugar is from about 20 to 40% (w/v).

In some embodiments, the sugar includes monosaccharide, oligosaccharide, polyhydric alcohol, or any combination thereof.

In some embodiments, the mixture homogeneity excipient is Triton X-102, Triton X-165, Triton X-305, Triton X-405 or any combination thereof.

In some embodiments, the mixture homogeneity excipient is Tween 20, Tween 40, Tween 60, Tween 80, or any combination thereof.

In some embodiments, a concentration of the mixture homogeneity excipient is about 0.5 to 5% (v/v).

In some embodiments, the bromine derivative of fluorescein comprises eosin Y, eosin B or any combination thereof.

In some embodiments, the solvent further includes phosphate buffered saline (PBS), ddH₂O, glycerol, or any combination thereof.

In some embodiments, a thickness of the specimen is up to about 1000 um.

In some embodiments, the pH is from about 6 to 8.

In some embodiments, the surfactant comprises Sodium dodecyl sulfate (SDS) or Triton X-100.

In some embodiments, a concentration of the surfactant is from about 1 to 5% (v/v).

In some embodiments, the composition further includes a second labeling material.

In some embodiments, a concentration of the bromine derivative of fluorescein is from about 1 to 4 mg/ml.

In some embodiments, the second labeling material includes DAPI, Propidium Iodide (PI), SYTO 16, SYTO 40, NucRed or NucGreen.

The present disclosure also reveals a kit for rendering a biological material transparent. The kit includes the above-mentioned composition.

In some embodiments, the kit further includes an anti-freezer, a humectant, or any combination thereof.

The present disclosure further reveals a method for making a biological material transparent and labeling the biological material simultaneously. The method includes the following steps: (A) fixing a specimen with a fixative solution, and (B) immersing and incubating the specimen in the composition to allow the composition to permeate the specimen.

After a permeated specimen is obtained, it may be imaged by an optical instrument. The imaging may be performed using fluorescent microscopy, confocal microscopy, light-sheet microscopy, two-photon microscopy, structured illumination microscopy or light-field microscopy.

In some embodiments, Step (A) further comprises: (A1) embedding the specimen into an embedding material.

In some embodiments, the specimen is processed through permeabilization, DAPI and eosin staining, and optical clearing in Step (B).

In some embodiments, a thickness of the specimen is about 100 to 1000 um. In another embodiments, the preferable thickness of the specimen is about 100 to 300 um.

In some embodiments, the method further comprises a step of staining the specimen by a second labeling material after Step (B).

In some embodiments, the method further comprises a step of cutting, by a sliding machine, the specimen into a smaller specimen between Step (A) and (B).

In some embodiments, Step (B) comprises incubation for at least 16 hours.

In some embodiments, Step (A) or (B) does not include a step for dehydration.

In some embodiments, the method further comprises a step for hybridizing the fixed specimen with a polymer.

In some embodiments, the polymer is hydrogel.

### BRIEF DESCRIPTION OF DRAWINGS

One or more embodiments are illustrated by way of example, and not by limitation, in the figures of the accompanying drawings, wherein elements are having the same reference numeral designations represent like elements throughout. The drawings are not to scale, unless otherwise disclosed.

FIG. 1A to 1D show the procedural flow of the staining and clearing method used in this study and three known staining and clearing techniques in the prior art. FIG. 1A shows the method of the present disclosure; FIG. 1B shows the hydrophilic reagent-based cleaning method; FIG. 1C shows the organic solvent-based cleaning method; and FIG. 1D shows the hydrogel embedding cleaning method.

FIGS. 2A and 2B show the eosin staining and imaging of biological tissue using the composition in the present disclosure and three other prior compositions combined with prior staining methods. FIG. 2A shows the prior eosin staining method, and FIG. 2B shows the final imaging results.

FIGS. 3A and 3B show the effects of various chemical substances, including those mentioned in the present disclosure, on the intensity of eosin fluorescence staining signals. FIG. 3A shows the fluorescence images of each group after staining, and FIG. 3B is a quantitative graph of the fluorescence intensity signals of each image in FIG. 3A.

FIGS. 4A to 4D demonstrate the effect of amide dye adjuvant on the binding affinity between eosin and tissue specimens. Specifically, FIGS. 4A and 4C show the final fluorescence images of different groups, and FIGS. 4B and 4D reveal the quantitative results of the corresponding eosin fluorescence intensity for each group of FIGS. 4A and 4C.

FIGS. 5A to 5C disclose the effect of Tween 20, Tween 60, Triton X-405, and DMSO in the present composition on the imaging quality.

FIG. 6 discloses the effect of the concentration of Triton X-100 in the present composition on the imaging quality.

FIG. 7A discloses the final image differences between not using the optical clearing solution, applying the present one to the prior staining procedure, and using the present one and its corresponding method. FIG. 7B discloses the procedures required for the above three methods and their corresponding time statistics.

FIG. 8A discloses the statistics of the procedure and the corresponding time required for the three methods, namely, the method for the present composition, the prior fluorescent staining, and the prior H&E staining. FIG. 8B discloses the statistics of the amount of tissue-related information that the three methods can obtain.

The drawings are only schematic and are non-limiting. In the drawings, the size of some of the elements may be exaggerated and not drawn on scale for illustrative purposes. The dimensions and the relative dimensions do not necessarily correspond to actual reductions to practice of the disclosure. Any reference signs in the claims shall not be construed as limiting the scope. Like reference symbols in the various drawings indicate like elements.

### DETAILED DESCRIPTION

The making and using of the embodiments of the disclosure are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Throughout the various views and illustrative embodiments, like reference numerals are used to designate like elements. Reference will now be made in detail to exemplary embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, an apparatus in accordance with the present disclosure. It is to be understood that elements not specifically shown or described may take various forms. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the features, structures, or characteristics may be combined in any suitable manner in one or more embodiments. It should be appreciated that the following figures are not drawn to scale; rather, these figures are merely intended for illustration.

In the drawings, like reference numbers are used to designate like or similar elements throughout the various views, and illustrative embodiments of the present disclosure are shown and described. The figures are not necessarily drawn to scale, and in some instances the drawings have been exaggerated and/or simplified in places for illustrative purposes. One of ordinary skill in the art will appreciate the many possible applications and variations of the present disclosure based on the following illustrative embodiments of the present disclosure.

### Definition

It will be understood that singular forms “a”, “an” and “the” are intended to include the plural forms as well, unless the context clearly indicates otherwise.

The term “about,” as used herein, when referring to a measurable value such as an amount, a temporal duration, and the like, is meant to encompass variations of +10% and more preferably +5% from the specified value, as such variations are appropriate to perform the disclosed methods.

As used herein, the terms “labeling material”, “dye”, “staining material” or “probe” are used interchangeably and refer to any material that is capable of targeting a specific molecule on a biological sample. It includes chemical compounds or biological compounds.

The term “depth,” as used herein, when referring to a measurable value such as an distance between the focal distance and the basal line of the sample.

As used herein, the terms “sample”, “clinical sample”, “specimen” or “biological sample” are used interchangeably and refer to any biological sample that may from a species other than human. It can be from any organism or any part of a body or tissue.

As used herein, the term “dehydration” refers to replacing water in tissue with other materials but does not include using RI-matching material to replace water in tissue.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The present disclosure teaches a clearing composition for rendering a biological material transparent. The clearing composition may also be referred to as “clearing solution”, “cleaning solution”, or “clearing composition”.

### EXAMPLE

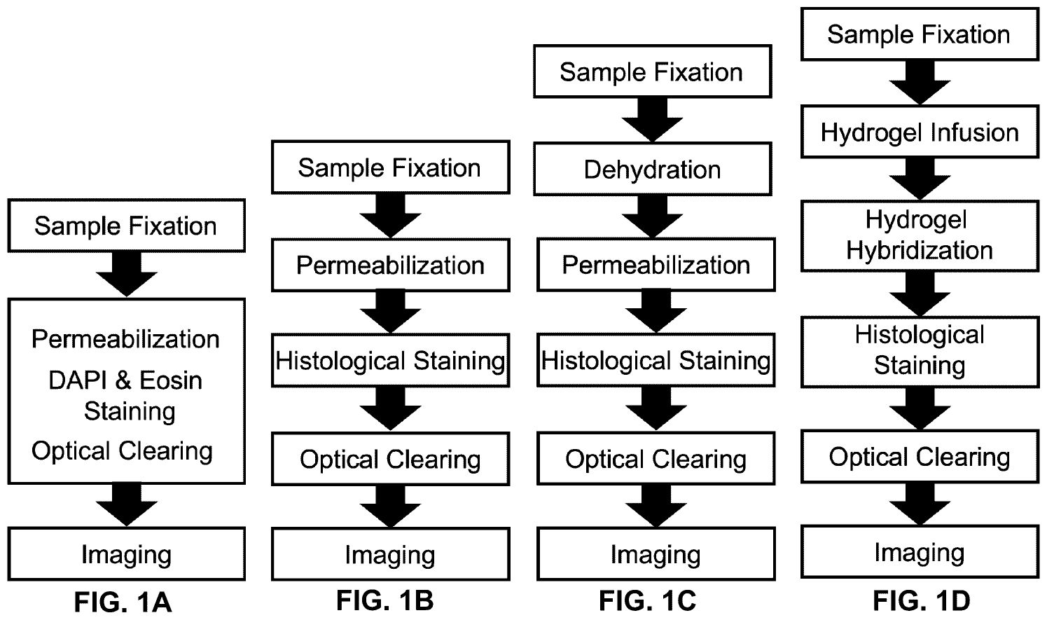

Please refer to FIGS. 1A to 1D. The figures illustrate a comparison between the staining process using the present composition disclosed herein and the staining process using prior technologies. FIG. 1A shows the method of the present disclosure; FIG. 1B shows the hydrophilic reagent-based cleaning method; FIG. 1C shows the organic solvent-based cleaning method; and FIG. 1D shows the hydrogel embedding cleaning method. The comparison clearly shows that the staining process using the present staining composition can combine the steps of permeabilization, DAPI & eosin staining, and optical clearing in a single step. In contrast, other prior staining methods require each step to be executed separately. This means that using the present composition for eosin staining and optical clearing can significantly reduce processing time and allow for more efficient tissue imaging. Moreover, the use of the disclosed composition and corresponding method in hospitals or inspection centers can eliminate the tedious steps and the need for a large amount of manpower in traditional methods. This enables the testing department to provide doctors with the required images more efficiently, thereby providing more timely evidence for interpretation.

It is important to note that the present composition can accomplish both eosin staining and optical clearing simultaneously. It is unlike prior clearing compositions, which cannot be used with eosin dye concurrently (such as the clearing composition for use in the method shown in FIG. 1C or 1D) or are incompatible with eosin staining (such as the clearing composition applied in the method shown in FIG. 1B). In other words, the combined eosin staining with optical clearing was only applicable to the organic solvent-based clearing method shown in FIG. 1C or the hydrogel embedding clearing method shown in FIG. 1D. The hydrophilic reagent-based clearing method in FIG. 1B was thought entirely unsuitable. This is mainly due to the fact that eosin is more soluble in organic solvents than in water. There is no doubt that the present method disclosed herein was considerably simpler than those shown in FIGS. 1C and 1D. As a result, the steps and time required to process a large number of samples can be substantially reduced. On the other hand, the cost of reagents required to be used in the process is significantly reduced due to the reduction in the number of steps to be taken, thus realizing a cost-saving advantage.

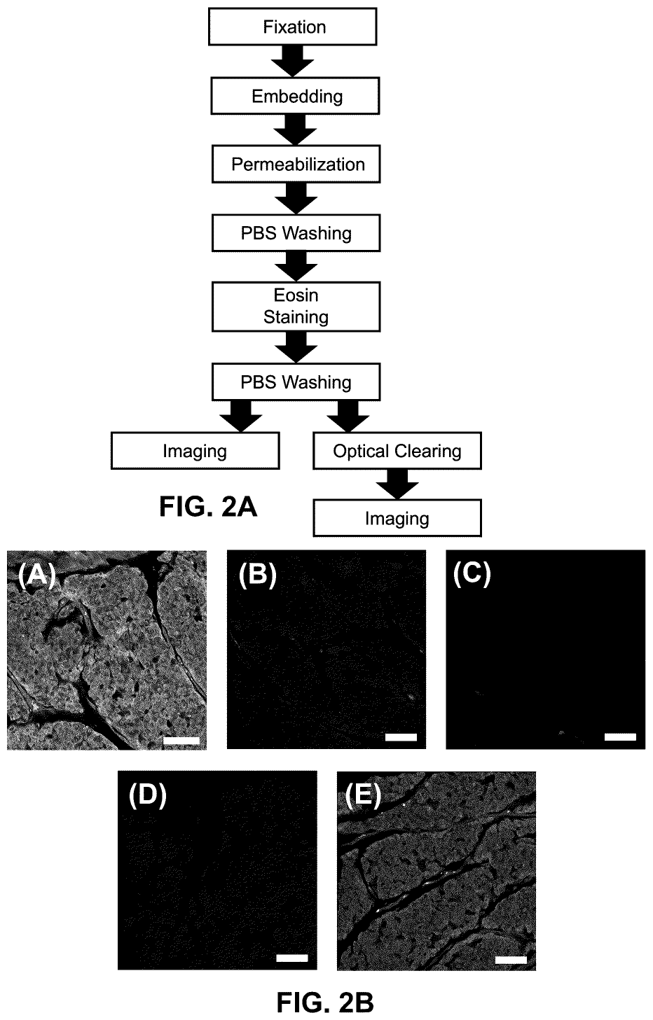

As previously mentioned, FIGS. 2A to 2B show the eosin staining and imaging of biological tissue using the composition in the present disclosure and three other prior compositions combined with prior staining methods. FIG. 2A discloses a general prior eosin staining method. Specifically, first, specimen was fixed with 10% neutral buffered formalin (NBF) for 6-72 hours at room temperature. Then, the fixed tissue specimen was embedded in a 3% (w/v) agarose gel solution at room temperature for 10 minutes and further at 4° C. for another 10 minutes. The fixed tissue specimen was sectioned into slices with a preferable thickness. Further, a sample was permeabilized with 2% Triton solution for at least 12 to 16 hours at 4° C. Then, the sample was removed from the Triton solution and washed thrice (10 minutes each time) with PBS. Next, the sample was stained with eosin for approximately 16 hours at room temperature. Once the staining reaction was complete, the sample was rewashed with PBS thrice (10 minutes each time). If the sample needs to conduct the tissue optical clearing procedure, eosin distribution (e.g., cytoplasm distribution) imaging must be obtained before the tissue optical clearing step can be performed. The tissue optical clearing step involved immersing the sample in a tissue optical clearing solution for approximately 16 hours at room temperature.

Please refer to FIG. 2B, which shows an example of using the method described in FIG. 2A to perform eosin staining on a human breast cancer tissue specimen. The image of Group (A) is that tissue specimen was imaged after eosin staining; however, the images of Groups (B) to (E) are that tissue specimens were subjected to tissue optical clearing steps and further imaged under a microscope. The white bar in the images of Groups (A) to (E) served as a scale and represents 100 μm. It is worth knowing that four tissue optical clearing solutions were used in this example. The four types of tissue optical clearing solutions were the present tissue optical clearing solution in the present disclosure and three existing prior tissue optical clearing solutions (FocusClear, Railcar, and FOCM). The image of Group (A) clearly showed that a clear image of cytoplasmic distribution could be obtained by imaging immediately after eosin staining. Please refer to the Images of Group (B) to (D) in FIG. 2B, when the prior tissue optical clearing solutions (i.e., FocusClear, RapiClear, and FOCM) were used for imaging after the optical clearing procedure, the eosin on the tissue specimen was washed off that makes it impossible to observe the cytoplasmic distribution. However, please refer to the Image of Group (E), using the present tissue optical clearing solution (see Table 1), eosin could still bind to the tissue sample even after tissue optical clearing steps, allowing for precise observation of the cytoplasmic distribution.

TABLE 1
The present tissue optical clearing solution

| Item | Description | Final Concentration | |
|---|---|---|---|
| Amide dye adjuvant | Acetamide | 5% | (w/v) |
| | Urea | 5% | (w/v) |
| RI Matching | Iodixanol | 20% | (w/v) |
| Material | D-Sorbitol | 20% | (w/v) |

| | | |
|---|---|---|
| Solvent | DMSO | N/A |
| | Glycerol | N/A |

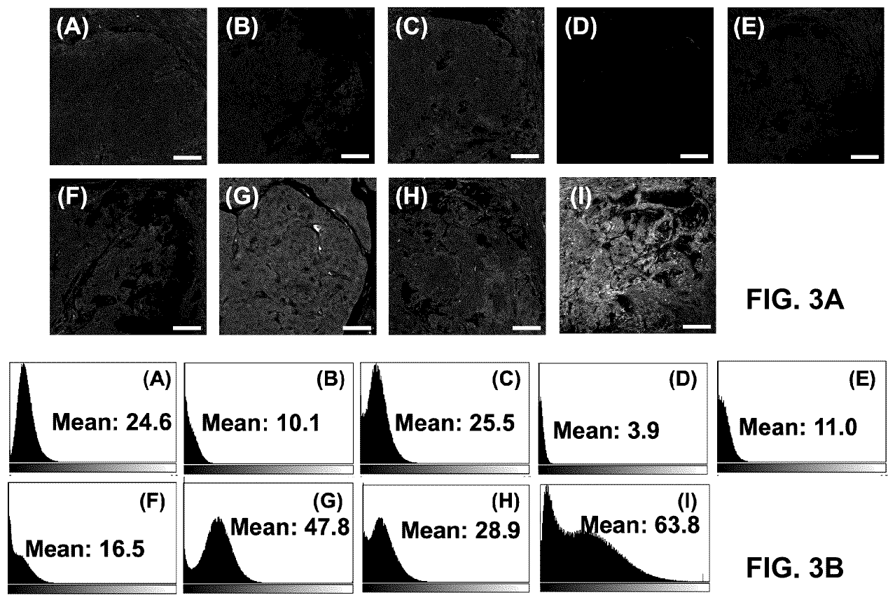

Please refer to FIGS. 3A and 3B, the figures show the effects of various chemical substances, including those mentioned in the present disclosure, on the intensity of eosin fluorescence staining signals. FIG. 3A shows the fluorescence images of each group after staining, and FIG. 3B is a quantitative graph of the fluorescence intensity signals of each image in FIG. 3A. To gain a better understanding of how different chemicals affect the ability of eosin to bind to tissue. The staining protocol of the present embodiment is as follows. Briefly, each group's human breast cancer tissue specimen was fixed with 10% neutral buffered formalin (NBF) for 6-72 hours at room temperature. Further, the fixed tissue specimen was embedded in a 3% (w/v) agarose gel solution at room temperature for 10 minutes and further at 4° C. for another 10 minutes. The fixed tissue specimen was sectioned into slices with a preferable thickness, such as 200 μm. Then, the specimens were permeabilized with 2% Triton solution for at least 12 to 16 hours at 4° C. After permeabilization, the specimens were washed thrice with PBS. Further, the specimens were stained with different groups (i.e., Group (A) to (I)) of staining solution having eosin for 16 hours at room temperature.

Specifically, the staining solution of Group (A) was Phosphate buffered saline (PBS) solution, the staining solution of Group (B) was 20% Dimethyl sulfoxide (DMSO) in PBS, the staining solution of Group (C) was 5% Glycerol in PBS, the staining solution of Group (D) was 2% (v/v) Triton X-100 in PBS, the staining solution of Group (E) was 33.7% (w/v) Iodixanol (i.e., contrast agent) in PBS, the staining solution of Group (F) was 30% (w/v) D-sorbitol in PBS, the staining solution of Group (G) was 40% (w/v) Fructose (i.e., monosaccharide or glucose) in PBS, the staining solution of Group (H) was 10% Urea in PBS, and the staining solution of Group (I) was 10% (w/v) Acetamide in PBS. Therefore, PBS was utilized as a diluent to dilute the chemical substances and fine-tune the final concentration. Once the staining reaction was complete, the specimen in each group was rewashed with PBS thrice and then conduct the imaging process by confocal microscopy. The images of FIG. 3A were captured using a microscope at a tissue depth of 30 μm. Before comparing the effect of different chemicals on the binding affinity between eosin and tissue, it is important to note that the staining solution of Group (A) was used as a control group. Based on the result of FIGS. 3A and 3B, it is clear that 5% Glycerol (Group (C)) and 10% Urea (Group (H)) didn't affect the binding affinity between eosin and tissue. However, 20% DMSO (Group (B)), 2% (v/v) Triton X-100 (Group (D)), 33.7% (w/v) Iodixanol (Group (E)), and 30% (w/v) D-sorbitol (Group (F)) significantly reduce the binding affinity. In the contract, 40% (w/v) Fructose (Group (G)) and 10% Acetamide (Group (I)) significantly increase the binding affinity.

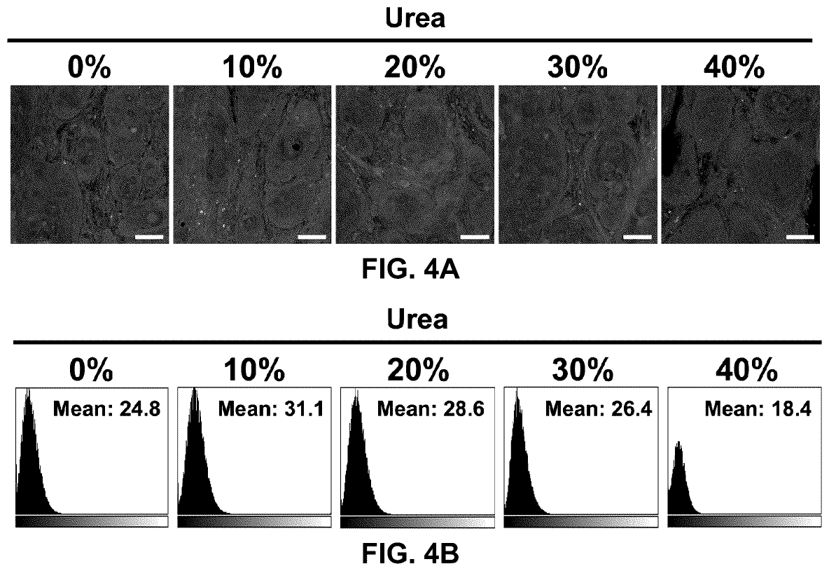

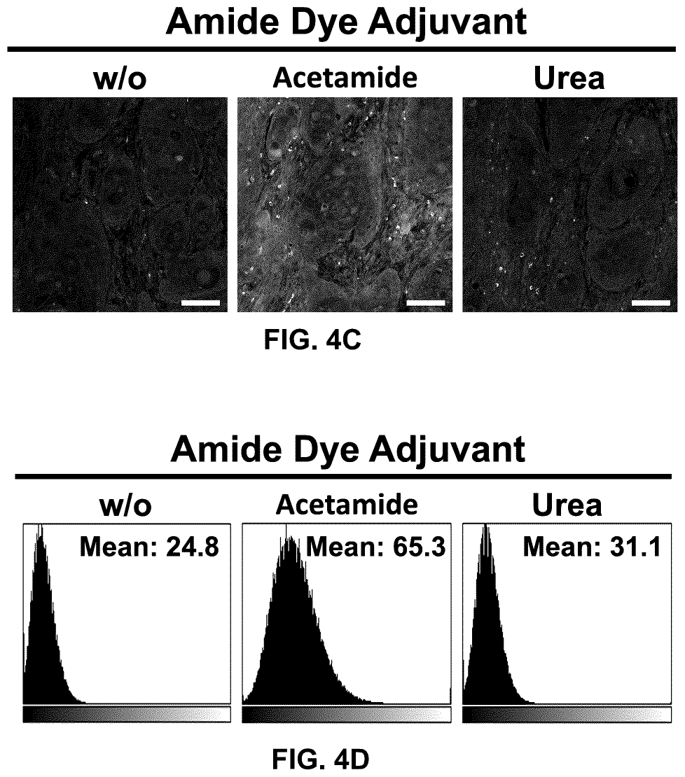

A further aspect that we would like to examine was how different concentrations of amide dye adjuvant affect the binding affinity of eosin to the tissue. In this embodiment, the amide dye adjuvant was Urea. Please refer to FIGS. 4A and 4B, the staining procedure is similar to FIGS. 3A and 3B. Briefly, each group's human oral cancer tissue specimen was fixed with 10% neutral buffered formalin for 6-72 hours at room temperature. Further, the fixed tissue specimen was embedded in a 3% (w/v) agarose gel solution at room temperature for 10 minutes and further at 4° C. for another 10 minutes. The fixed tissue specimen was sectioned into slices with a preferable thickness. Then, the specimens were permeabilized with 2% (v/v) Triton solution for 16 hours at 4° C. After permeabilization, the specimens were washed thrice with PBS. Further, the specimens were stained with different concentrations of Urea (0% to 40% (w/v)) having eosin for 16 hours at room temperature. Once the staining reaction was complete, the specimens were rewashed with PBS thrice and then conduct the imaging process by confocal microscopy. The images of FIG. 4A were captured using a microscope at a tissue depth of 30 μm. The white bar in FIG. 4A serves as a scale and represents 100 μm. According to FIGS. 4A and 4B, comparing the staining solution with 10% Urea or without Urea, the presence of Urea supports the binding ability of eosin to bind to tissues. Further, as the concentration of Urea in the staining solution increased (e.g., 10%, 20%, and 30% (w/v)), it enhances the binding affinity between eosin and tissue. However, too much Urea can significantly inhibit the ability of eosin to bind to tissues; for example, the figure shows that the fluorescence intensity of eosin in the group with 40% (w/v) Urea was lower than that in the group without Urea. Taken together, the Urea concentration that promoted eosin binding to cells ranges from 10% to 30% for clearly demonstrating the morphology of the cytosol of the tissue.

Further, we also examined whether Acetamide can be used as an amide dye adjuvant. In this embodiment, the examination procedure is similar to the previous protocol. The images of FIG. 4C were captured using a microscope at a tissue depth of 30 μm. The white bar in FIG. 4C serves as a scale and represents 100 μm. Please refer to FIGS. 4C and 4D, it is clear from the results that the absence of amide dye adjuvant resulted in poor eosin staining signals and unclear cell structure texture in the tissue. However, in groups where amide dye adjuvant is added (e.g., Urea or Acetamide), eosin can be stably bound to the cells (enhancing the staining effect), and at the same time, the cellular structure texture in the tissue could be clearly recognized. Further, Acetamide provides better staining enhancement than Urea.

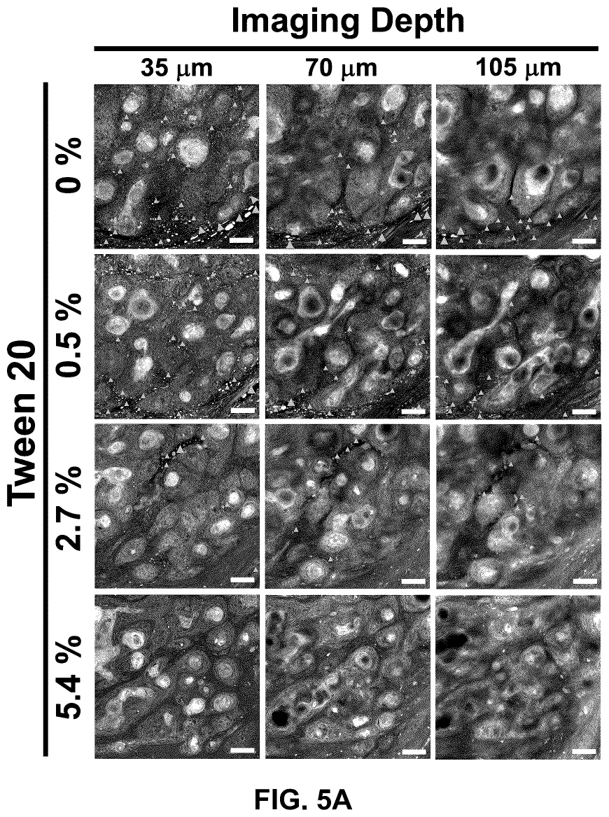

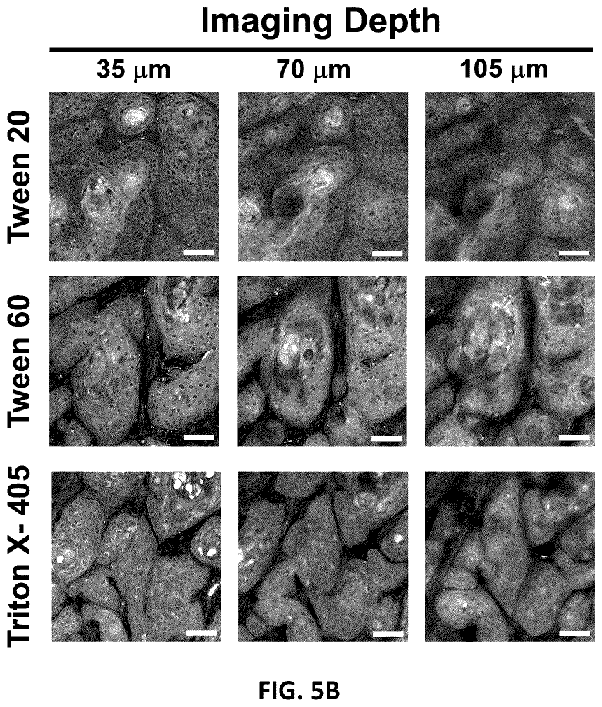

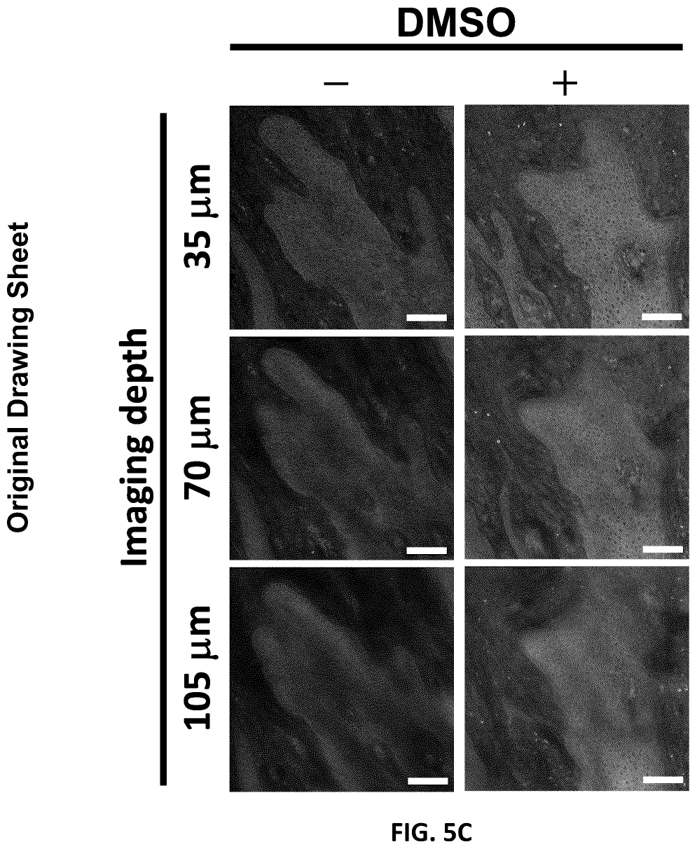

In the present optical clearing solution, Tween 20 was used as a mixture homogeneity excipient. In other words, the presence of Tween 20 allows eosin to be evenly distributed in the solution to promote uniformity of subsequent staining (i.e., Eosin can uniformly bind to the cytoplasm without aggregation). However, we would like to confirm whether the concentration of Tween 20 affects eosin's ability to bind to tissue. Please refer to FIG. 5A, in this embodiment, we used different concentrations of Tween 20 in the present clearing solution (see Table 2), but other compositions are the same as previously mentioned. Briefly, each group's human oral cancer tissue specimen is fixed with 10% neutral buffered formalin for 6-72 hours at room temperature. Further, the fixed tissue specimen was embedded in a 3% (w/v) agarose gel solution at room temperature for 10 minutes and further at 4° C. for another 10 minutes. The fixed tissue specimen was sectioned into slices with a preferable thickness. Then, the specimens were incubated with the present optical clearing solution having different concentrations of Tween 20 for 16 hours at room temperature. Once the reaction was complete, the imaging process was conducted by confocal microscopy. The images of FIG. 5A were captured using a microscope at a tissue depth of 35, 70, and 105 μm. The white bar in FIG. 5A serves as a scale and represents 100 μm. As FIG. 5A shows, comparing the 0% and 0.5% Tween 20 concentration groups, adding Tween 20 to the optical clearing solution significantly reduced the uneven staining caused by eosin agglutination (i.e., the location marked by the yellow triangle in the figures). Further, when the concentration of Tween 20 in the optical clearing solution was increased, the more eosin could be evenly dissolved in the solvent without causing particle precipitation, and the more precise the image was without being interfered with by the precipitation.

TABLE 2
The present optical clearing solution.

| Item | Description | Final Concentration | |
|---|---|---|---|
| Amide dye adjuvant | Acetamide | 5% | (w/v) |
| | Urea | 5% | (w/v) |
| RI Matching Material | Iodixanol | 20% | (w/v) |
| | D-Sorbitol | 20% | (w/v) |
| Permeating Agent | Triton X-100 | 1% | (v/v) |

| | | |
|---|---|---|
| Mixture Homogeneity Excipient | Tween 20 | 0 to 5.4% |
| Solvent | DMSO | N/A |
| | Glycerol | N/A |
| Labeling Material | Eosin Y | 1 mg/ml |

Next, we wanted to confirm the possible material that can also be used as a mixture homogeneity excipient of the present optical clearing solution for eosin staining. We choose Tween 20, Tween 60, and Triton X-405 as candidates in this embodiment. Please refer to FIG. 5B, we used same concentrations of Tween 20, Tween 60 or Triton X-405 in the present clearing solution (see Table 2), but other compositions are the same as previously mentioned. Further, the Briefly, each group's human oral cancer tissue specimen was fixed with 10% neutral buffered Formalin for 6-72 hours at room temperature. Further, the fixed tissue specimen was embedded in a 3% (w/v) agarose gel solution at room temperature for 10 minutes and further at 4° C. for another 10 minutes. The fixed tissue specimen was sectioned into slices. Then, the specimens were incubated with the present optical clearing solution having different mixture homogeneity excipients (e.g., Tween 20, Tween 60 and Triton X-405) for 16 hours at room temperature. Once the reaction was complete, then the imaging process was conducted by confocal microscopy. The images of FIG. 5B were captured using a microscope at a tissue depth of 35, 70, and 105 μm. The white bar in FIG. 5B serves as a scale and represents 100 μm. The results showed that the same concentration of Tween 20, Tween 60, or Triton X-405 can achieve the same effect (i.e., Eosin can be evenly dispersed in the solution to enhance the image quality). It is also worth noting that the hydrophile-lipophile balance (HLB) values of Tween 20, Tween 60, and Triton X-405 are 16.7, 14.9, and 17.6, respectively. Therefore, any substance with similar properties to Tween 20 and an HLB value between 14 and 18 can be used as a hydrophile-lipophile balance (HLB) value. Therefore, any substance with similar properties to Tween 20 and an HLB value between 14 and 18 can be used as a mixture homogeneity excipient in the present solution.

In an additional aspect, DMSO was also used as a solvent or diluent to dilute the labeling material (such as eosin or other fluorescent substances) and others chemical compound. Therefore, we also want to verify in this embodiment whether the addition of DMSO affects the imaging quality of eosin. The experiment procedure of FIG. 5C is similar to the experiments of FIG. 5A or 5B. Specifically, the difference is whether the present optical clearing solution includes DMSO. Further, ddH₂O was used to replace DMSO in the group without adding DMSO. The images of FIG. 5C were captured using a microscope at a tissue depth of 35, 70, and 105 μm. The white bar in FIG. 5C serves as a scale and represents 100 μm. As shown in the figure, if DMSO was not added to the present optical clearing solution, the eosin signal decreased, resulting in blurred cytoplasm and reduced transparency in the deeper layers, and the image becomes blurrier as the depth of the tissue image increases. However, if DMSO was added to the present optical clearing solution, the image quality can be improved, and the deeper layers of tissue can still be unquestionably recognized. Therefore, DMSO is indispensable in the present solution.

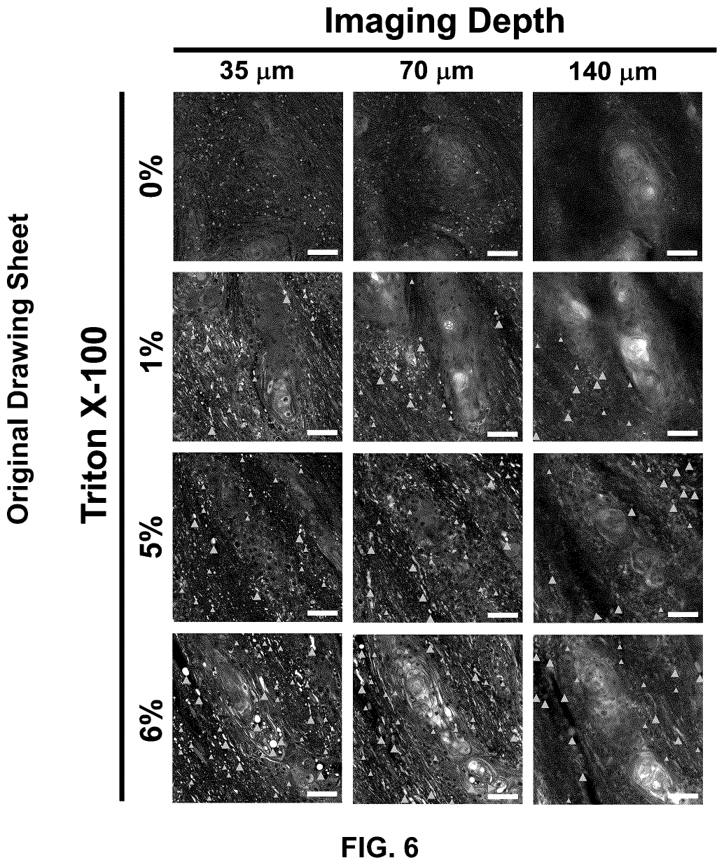

Next, we want to evaluate the effect of permeating agents in the present optical clearing solution on the binding affinity between eosin and tissue. Similar to the previous experiments, in this embodiment, we used different surfactant (e.g., Triton X-100) concentrations in the present clearing solution (see Table 2), but other compositions were the same as previously mentioned. The images of FIG. 6 were captured using a microscope at a tissue depth of 35, 70, and 140 μm. The white bar in FIG. 6 is a scale representing 100 μm. As shown in the figure, comparing the images of the two groups of 0% and 1% Triton X-100, it is clear that the addition of the Triton X-100 group can make the imaging of the cellular matter clearer, and the effect is more evident with the increase of the depth of the tissue image. In other words, even in the center of the tissue, the presence of Triton X-100 made it easier for eosin to penetrate deeper into the tissue and bind to it, and thus, the texture of the tissue pattern in the image was clearer than in the group without Triton X-100. Further, as the concentration of Triton X-100 in the present optical clearing solution increases (e.g., 1% and 5%), it enhanced eosin's penetration ability for more evident figures. However, too much Triton X-100 (e.g., 6% (v/v)) can significantly induce the aggregation of eosin (i.e., the location marked by the yellow triangle in the figures) and reduce an image's quality. Taken together, the Triton X-100 concentration that promotes eosin's penetration ability ranges from 1% to 5% (v/v) for clearly demonstrating the morphology of the cytosol of the tissue.

To further support the previous conclusions, we compare the imaging results of (Group A) utilizing a previously known staining step and not adding an optical clearing solution to the staining solution; (Group B) utilizing a previously known staining step, and further performing an optical clearing after PBS washing; (Group C) utilizing the present staining reagent containing an optical clearing solution and corresponding staining step, to further highlight the advantages and features of the present invention. To help you understand the differences between different experimental steps, the following briefly describes the steps and conditions associated with each experiment. Regarding Group A, a human oral cancer tissue specimen is fixed with 10% neutral buffered formalin for 6-72 hours at room temperature. Further, the fixed tissue specimen was embedded in a 3% (w/v) agarose gel solution at room temperature for 10 minutes and further at 4° C. for another 10 minutes. The fixed tissue specimen was sectioned into slices. Then, the specimens were permeabilized with 2% (v/v) Triton solution for 16 hours at 4° C. After permeabilization, the specimens are washed thrice with PBS. Further, the specimens are stained with staining solution having eosin (1 mg/ml) and DAPI (1 mg/ml) for 16 hours at room temperature. Once the staining reaction was complete, the specimens were rewashed with PBS thrice and then conduct the imaging process by confocal microscopy. Regarding Group B, the process before the secondary PBS wash was the same as Group A, and the differences further include an optical clearing procedure between the secondary PBS wash and the imaging procedure, in which the specimens were incubated with the present optical clearing solution for 16 hours at room temperature. Regarding Group C, a human oral cancer tissue specimen was fixed with 10% neutral buffered formalin at room temperature for 6-72 hours. Further, the fixed tissue specimen was embedded in a 3% (w/v) agarose gel solution at room temperature for 10 minutes and further at 4° C. for another 10 minutes. The fixed tissue specimen was sectioned into slices. Then, the specimen is incubated with the present composition (see Table 3) for at least 16 hours at room temperature. Once the reaction was complete, the specimen was conducted through the imaging process.

TABLE 3
The present composition

| Item | Description | Final Concentration | |
|---|---|---|---|
| Amide dye adjuvant | Acetamide | 5% | (w/v) |
| | Urea | 5% | (w/v) |
| RI Matching Material | Iodixanol | 20% | (w/v) |
| | D-Sorbitol | 20% | (w/v) |
| Permeating Agent | Triton X-100 | 1% | (v/v) |

| | | |
|---|---|---|
| Mixture Homogeneity Excipient | Tween 20 | 0.5% |
| Solvent | DMSO | N/A |
| | Glycerol | N/A |
| Labeling Material | Eosin Y | 1 mg/ml |
| | DAPI | 1 mg/ml |

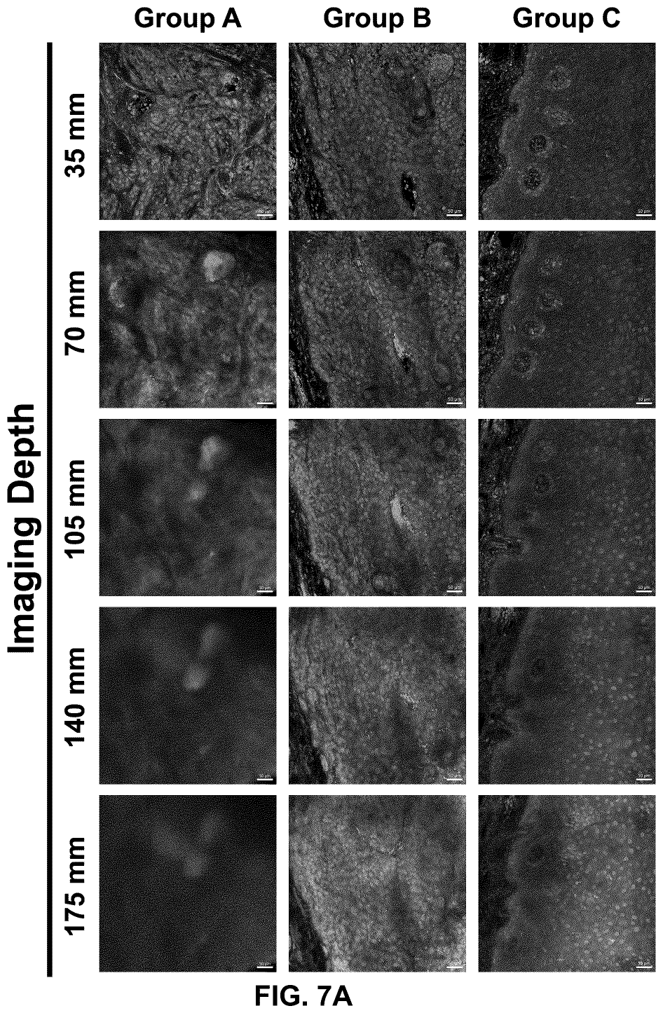

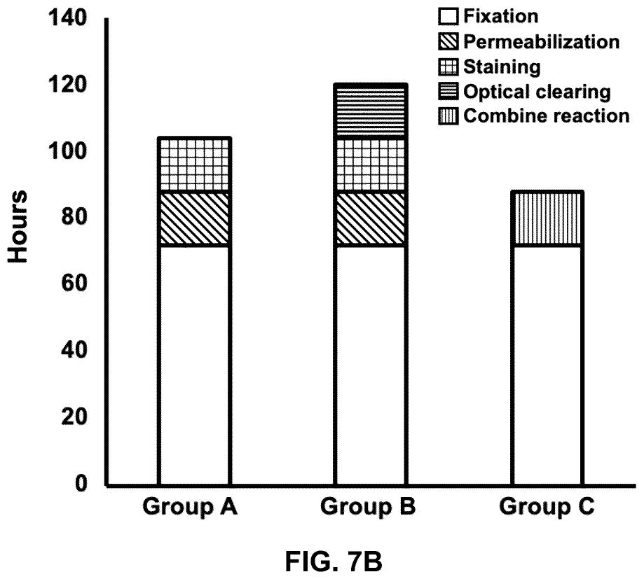

Please refer to FIG. 7A, the images were captured using a microscope at a tissue depth of 35, 70, 105, 140 and 175 μm. The white bar in FIG. 7A serves as a scale and represents 50 μm. Further, the green color in the image shows the binding of eosin to the cytoplasm, collagen, and muscle fibers in the tissue, and the red color shows the binding of DAPI to the nucleus in the tissue. Comparing the results of Groups A and B in FIG. 7A, without the addition of an optical clearing solution, when the depth of the tissue exceeds 70 μm, the shape of the tissue becomes blurred, and the image quality deteriorates as the depth increases. However, with the addition of an optical clearing solution, the shape of the tissue remains clear and intact even when the depth of the tissue exceeds 70 μm. Comparing the results of Group B and C in FIG. 7A, as long as an optical clearing solution was added, the quality of the staining result can be enhanced, and good image quality can be achieved within a specific range of tissue thickness. The limit of the tissue thickness to which the present solution is applicable is about 1,000 μm; preferably, the tissue thickness to which the present solution is applicable is about 100 to 1,000 μm; optimally, the tissue thickness to which the present solution is applicable is about 100 to 300 μm. Further information can be found in FIG. 7B, from the statistics of the total time spent on the experiments of Groups A, B, and C, it can be seen that: (1) the time spent on the experiment of Group B is longer than that of Group A, although Group B can obtain better image results compared to Group A; (2) the time spent on the experiment of Group B was longer than that of Group C, but the quality of the images of the two experiments was almost the same and the quality of the images of the two experiments is better than that of Group A; and (3) the Group C experiment took the least amount of time among the three experiments.

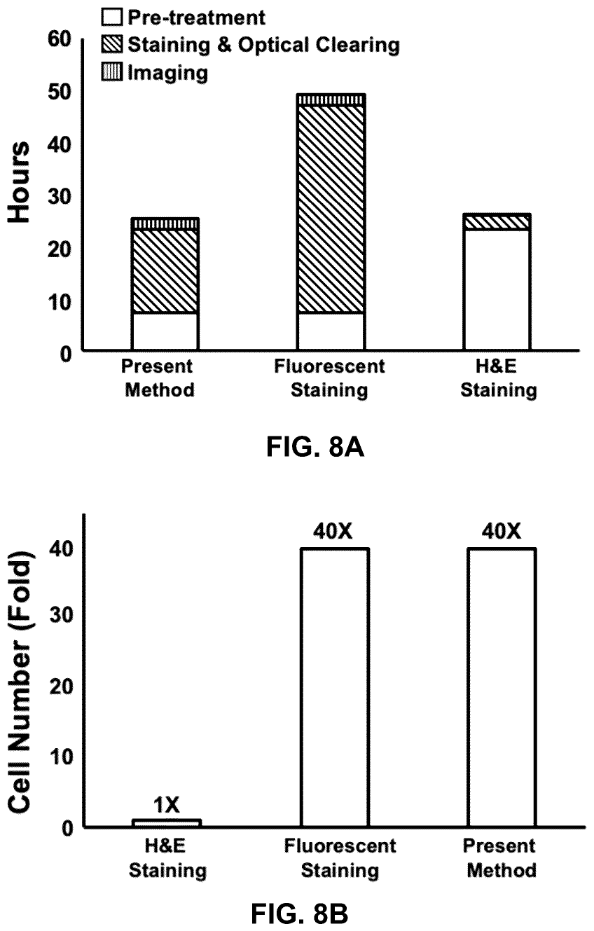

Please refer FIGS. 8A and 8B, the results evidently demonstrate the advantages (e.g., time and amount of cell information available) of the method of present composition disclosed herein over the prior fluorescent staining or the prior H&E staining. Specifically, based on the result of FIG. 8A and Table 4, the total time of the present method is similar to the prior H&E staining method, but both these methods (25.2 or 26 hours) are significantly less than the prior fluorescent staining (49.2-65.2 hours). Please refer to FIG. 8B, the information obtained by the present method, or the prior fluorescent staining method is significantly more than that obtained by the prior H&E dyeing method. Specifically, the paraffin sections' thickness in H&E staining is about 5 μm. However, the thickness of the post-tissue sections used in fluorescent staining or the present method in the present disclosure can be up to 200 μm, and multilayer scans are performed to obtain images, so there is a 40-fold difference in the cell count information between the two. In summary, the compositions and methods disclosed herein can provide a very efficient method (i.e., significantly reduce intermediate processing time) and can also provide more organizational information.

TABLE 4
Procedures required for each staining method and their corresponding time required.

| | | | | Staining & | | |
|---|---|---|---|---|---|---|
| | Pre-treatment | | | Optical | | Total |
| Type | Fixation | Embedding | Sectioning | Clearing | Imaging | (Hours) |
| Present Method | ≥6 | 0.7 | 0.5 | 16 | 2 | 25.2 |
| Prior Fluorescent | ≥6 | 0.7 | 0.5 | 40-56 | 2 | 49.2-65.2 |
| Staining | | | | | | |
| Prior H&E Staining | ≥6 | 17 | 0.2 | 2.7 | 0.1 | 26 |

1. A composition for tissue staining and optical clearing of a three-dimensional specimen, comprising:
an amide dye adjuvant, wherein a concentration of the amide dye adjuvant is from about 10 to 30% (w/v);
a Refractive Index matching material, comprising a contrast agent and a sugar;
a permeating agent, comprising a surfactant;
a first labeling material, comprising a bromine derivative of fluorescein;
a mixture homogeneity excipient, wherein a hydrophilic-lipophilic balance value of the mixture homogeneity excipient is from about 14 to 18; and
a solvent, comprising Dimethyl sulfoxide,
wherein the composition has a neutral or acidic pH.

2. The composition of claim 1, wherein the amide dye adjuvant comprises acetamide, urea, or a derivative thereof.

3. The composition of claim 1, wherein the sugar comprises monosaccharide, oligosaccharide, polyhydric alcohol, or any combination thereof.

4. The composition of claim 1, wherein the mixture homogeneity excipient is Triton X-102, Triton X-165, Triton X-305, Triton X-405, or any combination thereof.

5. The composition of claim 1, wherein the mixture homogeneity excipient is Tween 20, Tween 40, Tween 60, Tween 80, or any combination thereof.

6. The composition of claim 1, wherein a concentration of the mixture homogeneity excipient is about 0.5 to 5% (v/v).

7. The composition of claim 1, wherein the bromine derivative of fluorescein comprises eosin Y, eosin B, or any combination thereof.

8. The composition of claim 1, wherein the solvent further comprises phosphate buffered saline, ddH₂O, glycerol, or any combination thereof.

9. The composition of claim 1, wherein a thickness of the specimen is up to about 1,000 μm.

10. The composition of claim 1, wherein the pH value is 6 to 8.

11. The composition of claim 1, wherein the surfactant comprises SDS or Triton X-100.

12. The composition of claim 11, wherein a concentration of the surfactant is from about 1 to 5% (v/v).

13. The composition of claim 12, wherein a concentration of the bromine derivative of fluorescein is from about 1 to 4 mg/ml.

14. The composition of claim 1, further comprises a second labeling material.

15. The composition of claim 14, wherein the second labeling material comprises DAPI, PI, SYTO 16, SYTO 40, NucRed or NucGreen.

16. A kit for rendering a biological material transparent, comprising the composition of claim 1.

17. The kit of claim 16 further comprises an anti-freezer, a humectant, or any combination thereof.

18. A method for making a biological material transparent and labeling the biological material simultaneously, comprising:
(A) fixing a specimen with a fixative solution; and
(B) immersing and incubating the specimen in the composition of claim 1 to allow the composition to permeate the specimen.

19. The method of claim 18, wherein Step (A) further comprises: (A1) embedding the specimen into an embedding material.

20. The method of claim 18, wherein the specimen is processed through permeabilization, DAPI and eosin staining, and optical clearing in Step (B).

21. The method of claim 18 further comprises a step of staining the specimen by a second labeling material after Step (B).

22. The method of claim 18 further comprises a step of cutting, by a sliding machine, the specimen into a smaller specimen between Step (A) and (B).

23. The method of claim 18, wherein Step (B) comprises incubation for at least 16 hours.

24. The method of claim 18, wherein Step (A) or (B) does not include a step for gradient dehydration.

25. The method of claim 18, further comprises a step for hybridizing the fixed specimen with a polymer.

26. The method of claim 25, wherein the polymer is hydrogel.
